(19) United States
(12) Patent Application Publication
(10) Pub. No.: US 2012/0026168 A1
(43) Pub. Date: Feb. 2, 2012

(54) SYSTEM AND METHOD FOR INTERACTIVE LIVE-MESH SEGMENTATION

(75) Inventors: Torbjoern Vik, Hamburg (NO); Heinrich Schulz, Hamburg (DE)

(73) Assignee: KONINKLIJKE PHILIPS ELECTRONICS N.V., EINDHOVEN (NL)

(21) Appl. No.: 13/262,749

(22) PCT Filed: Mar. 2, 2010
(86) PCT No.: PCT/IB2010/050897

§ 371 Date: Oct. 3, 2011

Related U.S. Application Data
(60) Provisional application No. 61/166,263, filed on Apr. 3, 2009.

(51) Int. Cl. G06T 17/20

(52) U.S. Cl. 345/423

(57) ABSTRACT

A system and method for segmenting an anatomical structure. The system and method initiating a segmentation algorithm, which produces a surface mesh of the anatomical structure from a series of volumetric images, the surface mesh formed of a plurality of polygons including vertices and edges, assigning a spring to each of the edges and a mass point to each of the vertices of the surface mesh, displaying a 2D reformatted view including a 2D view of the surface mesh and the anatomical structure, adding pull springs to the surface mesh, the pull springs added based upon a selected point on a surface of the surface mesh and moving a portion of the surface mesh via an interactive point.

### BACKGROUND

Segmentation is the process of extracting anatomic configurations from images. Many applications in medicine require segmentation of standard anatomy in volumetric images acquired through CT, MRI and other forms of medical imaging. Clinicians, or other professionals, often use segmentation for treatment planning. Segmentation can be performed manually, wherein the clinician examines individual image slices and manually draws two-dimensional contours of a relevant organ in each slice. The hand-drawn contours are then combined to produce a three-dimensional representation of the relevant organ. Alternatively, the clinician may use an automatic segmentation algorithm that examines the image slices and determines the two-dimensional contours of a relevant organ without clinician involvement.

Segmentation using hand-drawn contours of image slices, however, is time-consuming and typically accurate only up to approximately two to three millimeters. When drawing hand-drawn contours, clinicians often need to examine a large number of images. Moreover, the hand-drawn contours may differ from clinician to clinician. In addition, automatic algorithms are often not reliable enough to solve all standard segmentation tasks. Making modifications to results obtained by automatic algorithms may be difficult and counterintuitive.

The result of many automatic segmentation algorithms is a three-dimensional surface represented as a mesh composed of a number of triangles. In order to perform modifications to the result it is therefore necessary to have intuitive mesh interaction tools. Some approaches to mesh interaction such as, for example, explicit displacement of vertices, often result in meshes that have ragged surfaces or large triangles/polygons in certain regions. Furthermore, since it is preferable to do modifications in a two-dimensional reformatted slice view of the image, undesirable changes in the image often occur distant from the reformatted plane.

### SUMMARY OF THE INVENTION

A method for segmenting an anatomical structure. The method including initiating a segmentation algorithm, which produces a surface mesh of the anatomical structure from a series of volumetric images, the surface mesh formed of a plurality of polygons including vertices and edges, assigning a spring to each of the edges and a mass point to each of the vertices of the surface mesh, displaying a 2D reformatted view including a 2D view of the surface mesh and the anatomical structure, adding pull springs to the surface mesh, the pull springs added based upon a selected point on a surface of the surface mesh and moving a portion of the surface mesh via an interactive point.

A system for segmenting an anatomical structure having a processor initiating a segmentation algorithm, which produces a surface mesh of the anatomical structure from a series of volumetric images, the surface mesh formed of a plurality of polygons including vertices and edges, and assigning a spring to each of the edges and a mass point to each of the vertices of the surface mesh, a display displaying a 2D reformatted view including a 2D view of the surface mesh and the anatomical structure and a user interface adapted to allow a user to add pull springs to the surface mesh, the pull springs added based upon a selected point on a surface of the surface mesh and moving a portion of the surface mesh via an interactive point.

A computer readable storage medium including a set of instructions executable by a processor. The set of instructions operable to initiate a segmentation algorithm, which produces a surface mesh of an anatomical structure from a series of volumetric images, the surface mesh formed of a plurality of polygons including vertices and edges, assign a spring to each of the edges and a mass point to each of the vertices of the surface mesh, display a 2D reformatted view including a 2D view of the surface mesh and the anatomical structure, add pull springs to the surface mesh, the pull springs added based upon a selected point on a surface of the surface mesh and move a portion of the surface mesh via an interactive point.

### BRIEF DESCRIPTION OF THE DRAWINGS

FIG. 1 shows a schematic view of a system according to an exemplary embodiment.

FIG. 2 shows a flow chart of a method according to an exemplary embodiment.

FIG. 3 shows a flow chart of a method according to an alternate embodiment.

FIG. 4 shows a flow chart of a method according to another embodiment.

FIG. 5 shows a perspective view of a portion of a surface mesh according to an exemplary embodiment.

### DETAILED DESCRIPTION

The exemplary embodiments set forth herein may be further understood with reference to the following description and the appended drawings, wherein like elements are referred to with the same reference numerals. The exemplary embodiments relate to a system and method for segmentation of a standard anatomy in volumetric images acquired through CT, MRI, etc. In particular, the exemplary embodiments describe a method for performing modifications to an approximate segmentation in a two-dimensional (2D) reformatted view, in an intuitive manner. It will be understood by those of skill in the art that although the exemplary embodiments describe a segmentation of an organ, the following systems and methods may be used to segment any three-dimensional (3D) anatomical structure from the volumetric images.

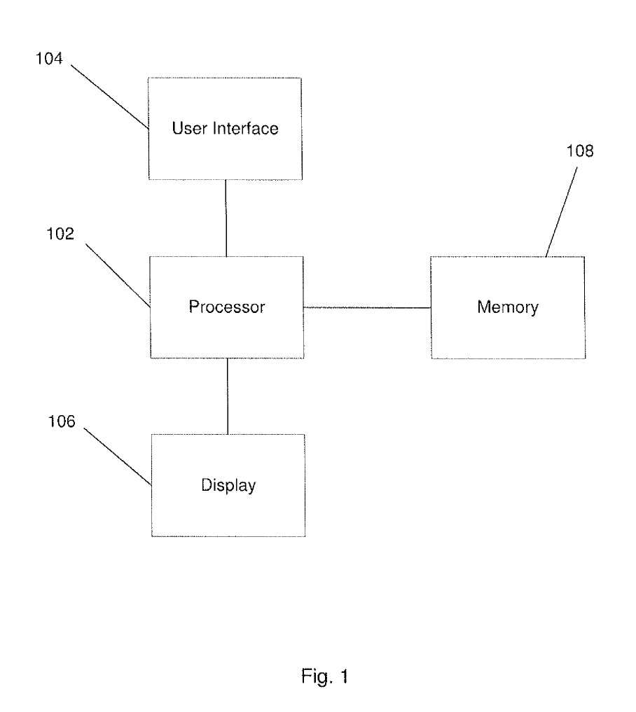

According to one exemplary embodiment in FIG. 1, a system 100 is capable of making modifications to an initial segmentation of an organ or other anatomical structure. The system 100 comprises a processor 102 that is capable of processing a segmentation algorithm on a series of volumetric images (e.g., acquired through MRI, CT) to complete an initial segmentation. The segmentation algorithm operates either automatically (without user involvement) or semi-automatically to complete the initial segmentation. In automatic operation, the segmentation algorithm analyzes the image slices and determines the two-dimensional contours of a relevant organ in an image slice without user involvement to complete the initial segmentation. In semi-automatic operation, the user may select a contour or image detail and the algorithm may then complete the initial segmentation based on this selection. The initial segmentation is represented by a surface mesh. The processor 102 is further capable of interpreting a user input via a user interface 104 of the system 100. The system 100 further comprises a display 106 for displaying the surface mesh representation and a memory 108 for storing at least one of the segmentation algorithm, the volumetric images, and the initial surface mesh representation. The memory 108 is any known type of computer-readable storage medium. It will be understood by those of skill in the art that the system 100 is a personal computer, a server, or any other processing arrangement.

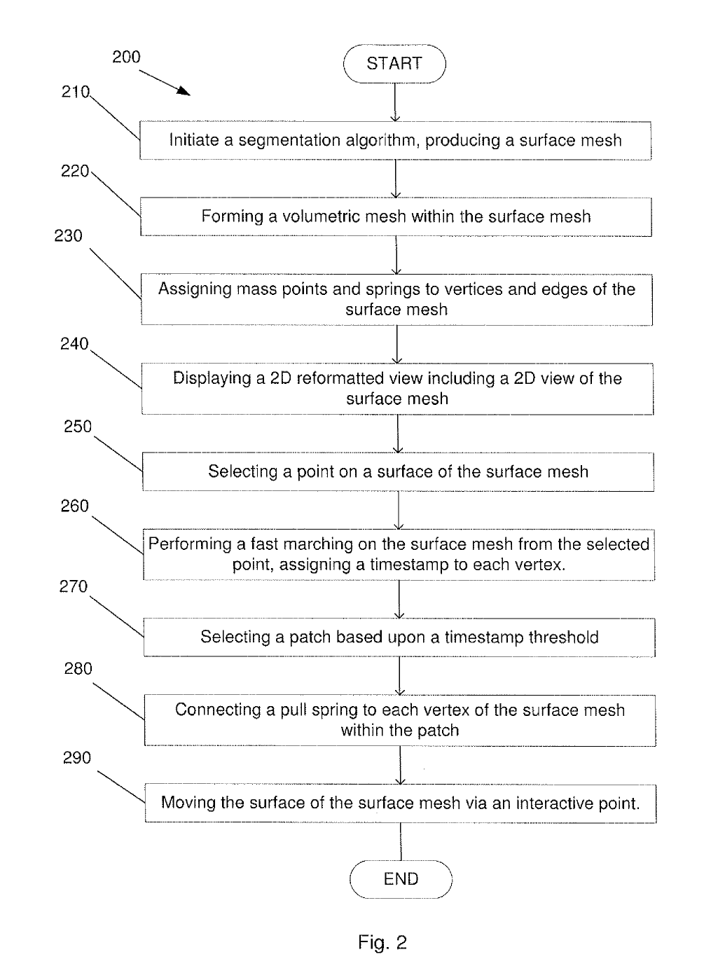

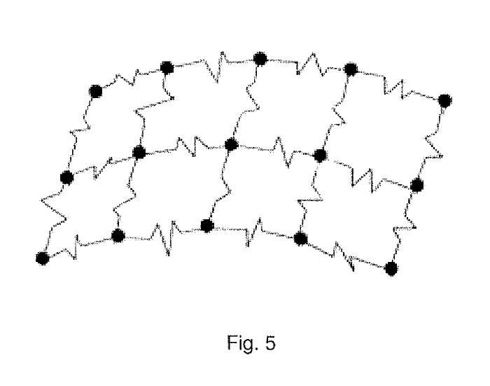

As shown in FIG. 2, method 200 comprises initiating a segmentation algorithm, in a step 210, to complete the initial segmentation of an imaged organ, or other anatomic structure, in the series of volumetric images. The initial segmentation is represented by a surface mesh that is comprised of triangular polygons formed of vertices and edges. For example, FIG. 5 shows an example of a portion of a surface mesh comprising vertices and edges. It will be understood by those of skill in the art that the surface mesh acts as a model or mean organ that may be interactively modified via the user interface 104. In a step 220, the processor 102 further creates a volumetric mesh, which is contained within the surface mesh such that vertices and edges of the volumetric mesh are within the vertices and edges of the surface mesh formed by the segmentation algorithm. The volumetric mesh includes vertices and edges corresponding to each of the vertices and edges of the surface mesh.

In a step 230, the processor 102 assigns vertices and edges of the surface mesh with mass points and springs, respectively. Each edge of the surface mesh corresponds to a spring while each vertex of the surface mesh corresponds to a mass point. The rest length of each spring may be substantially equal to a length of the corresponding edge of the surface mesh. In a simple version, each mass point has unit mass and each spring has the same spring constant. However, it will be understood by those of skill in the art that the mass and spring constant may vary according to prior knowledge about the organ or other anatomic structure that the surface mesh represents. For example, some parts of the organ or structure may be stiffer or more rigid than other parts. Further, image forces may be added by weighting mass points of vertices based upon an image gradient, which represents an object boundary such that high mass points will be assigned for vertices where the image gradient is high, preventing unnecessary movement where the vertex corresponds to the surface of the imaged organ. In a step 240, a 2D reformatted view is displayed on the display 106. The 2D reformatted view includes a 2D view of the surface mesh along with the imaged organ. It will be understood by those of skill in the art that the 2D reformatted view is an image from the series of volumetric images that has been reformatted to show the 2D image of both the surface mesh and the imaged organ. It will also be understood by those of skill in the art that the surface mesh is displayed in a position, which corresponds to a position of the imaged organ in the displayed image.

Once the surface mesh has been appropriately assigned with the mass points and springs, pull springs are added to the surface mesh to interactively modify the surface mesh. In a step 250, a point on a surface of the surface mesh is selected. The point on the surface of the surface mesh is selected by a user via the user interface 104. For example, the user interface 104 includes a mouse, which may be used to point to and click on a point on the surface mesh. Alternatively, the user interface 104 may include a touch interface such that the point may be selected by touching a point on the surface of the surface mesh on the display 106. The user selects a point either at random or according to a portion of the surface that the user desires to correct or modify. The selected point will be the point of interaction.

In an alternative embodiment, the selected point may be a feature point on the surface of the surface mesh, which may be identified by the processor 102 or by the user via the user interface 104. It will be understood by those of skill in the art that identifying feature points allows image forces to be added to the surface mesh. For example, the processor 102 may identify feature points that show typical characteristics of a point (e.g., corner feature) or contour (e.g., gradient feature) such that placing a mouse pointer in the vicinity of the feature point will result in the pointer “snapping” to the feature point and thereby selecting the feature point. It will be understood by those of skill in the art that the user may select more than one point on the surface of the surface mesh. It will also be understood by those of skill in the art that the selected points may also be set (e.g., according to feature points) such that they are changeable by the user.

In a step 260, the processor performs a fast-marching method on the surface mesh, starting from the point selected by the user. Those of skill in the art will understand that a fast marching method is a method of boundary value formulation. The fast-marching method assigns a timestamp to each of the vertices on the surface mesh, the timestamp for each vertex being determined by a distance of the vertex from the selected point. Thus, vertices farther away from the selected point are assigned a higher timestamp, while vertices closer to the selected point are assigned a lower timestamp. The fast-marching method may also take local orientation of the surface polygons (e.g., triangles) of the surface mesh into consideration. For example, differences in surface normals may incur a higher time cost. Once the fast-marching method has been performed, a patch of the surface mesh is selected based upon a time threshold, in a step 270. For example, the selected patch includes all polygons reached within a certain amount of time. It will be understood by those of skill in the art that the time threshold may be predetermined by the user prior to use. Thus, the processor 102 may automatically select the patch according to the predetermined threshold. It will also be understood by those of skill in the art, however, that the patch may be selected by the user based upon a threshold determined by the user during use.

In a step 280, a pull spring is attached to each of the vertices in the patch. The pull spring is attached to each vertex such that a first end of the pull spring is attached to the vertex of the surface mesh while a second end of the pull spring is attached to the corresponding vertex of the volumetric mesh. Each pull spring will have a rest length of zero. A spring constant of each pull spring is weighted according to the corresponding timestamp of the corresponding vertex. For example, pull springs may be down-weighted with respect to closer pull springs. Alternatively, vertices with higher timestamps may be accorded higher masses or may be fixed such that the vertices may not move. It will be understood by those of skill in the art that higher masses or fixing the vertices so that the vertices are unable to move prevents non-intuitive changes to the surface mesh, which are far from the selected point of interaction. It will also be understood by those of skill in the art that the step 270 is not required. Where a patch is not selected, a pull spring is simply attached from the selected point to a vertex closest to a vertex of the surface mesh closest to the selected point.

In a step 290, the user interactively moves the surface of the surface mesh via an interactive point. The interactive point may be the point selected in step 250. The interactive point may also be a feature point that shows typical characteristics of a point (e.g., corner feature) or contour (e.g., gradient feature). The interactive point is moved to a desired location. The desired location may be a corresponding point on a surface of the imaged organ in the 2D reformatted view. It will be understood by those of skill in the art that where the interactive point is close to a feature point, the feature point may be removed to permit movement of the interactive point. During interaction, a numerical solver continuously solves a Netwonian equation for each vertex of the surface mesh such that moving the selected point moves the surface of the surface mesh via the pull springs attached to each of the vertices. Since each pull spring may be assigned a different spring constant based on the timestamp, it will be understood by those of skill in the art that each vertex may move varying distances such that the surface of the surface mesh moves in an intuitive manner. The distance that each of the vertices will be moved is calculated using the Newtonian equation, F=ma, where a=d(dx/dt), F being the force acting on the vertex, m being the mass of the vertex and x being the position of the vertex. Thus, it will be understood by those of skill in the art that the distance moved by each of the vertices is determined based upon a distance from the selected point (i.e., the point of interaction). The processor 102 uses any standard solver such as, for example, Euler Runge-Kutta, which is preloaded into the memory 108 of the system 100, or is otherwise made available for use. It will be understood by those of skill in the art that the steps 250-290 may be repeated until the surface mesh has been modified as desired.

In an alternative embodiment, the point of interaction of step 290 is selected based on the form of the surface mesh. For example, where the surface mesh is jagged, a jagged corner of the surface mesh is selected and a distance map of ends of the corner is determined and subtracted to reduce the jagged edge. In a further embodiment, the interactive point of the step 290 is a steerable ball or point that is moved by the user via the user interface 104. The steerable ball may be either two dimensional or three dimensional, creating an attraction/repulsion field such that any of the vertices that fall within the sphere of the streerable ball is attracted or repelled to move the vertex in line with a motion of the steerable ball. For example, force of attraction/repulsion are determined by using the formula:

$${f}_{att} ( x ) = \{ \begin{matrix}\frac{ɛ}{{\vert r \vert}^{2}} \cdot \frac{r}{\vert r \vert} & if \vert r \vert \leq {r}_{ma x} \\ 0 & otherwise ,\end{matrix}$$

where x is a position of the steerable ball, rₘₐₓ is a radius of the steerable ball, ε=±1 and r=x−c, where c is a center of the steerable ball.

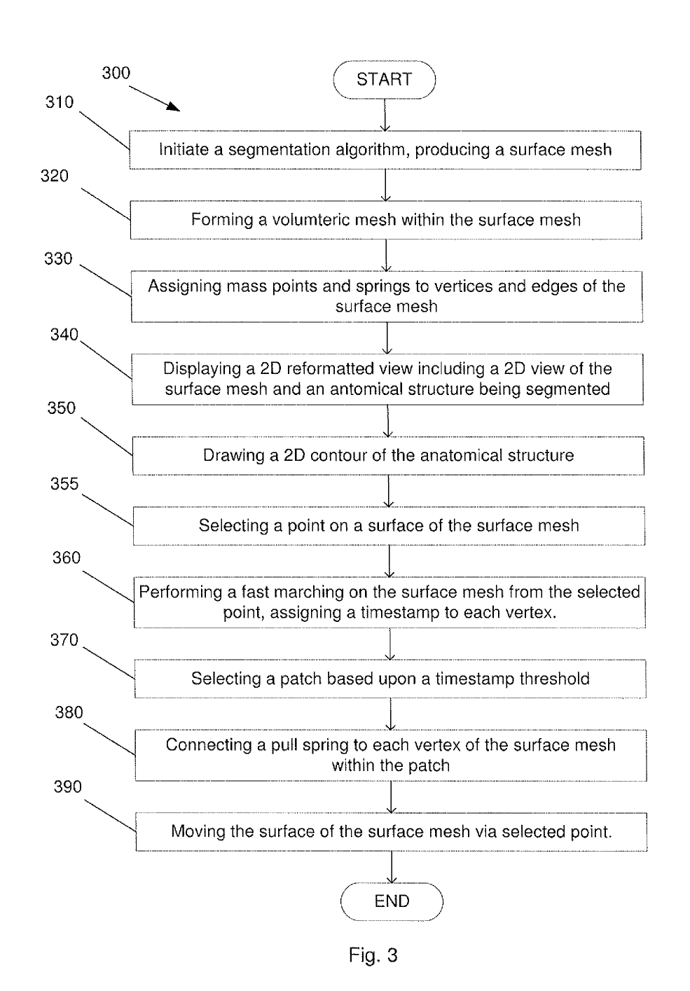

FIG. 3 shows a method 300, which is substantially similar to the method 200, described above. The method 300 differs in user selection of interaction points. Steps 310-340 are substantially similar to steps 210-240 of the method 200. The method 300 comprises initiating a segmentation algorithm, in the step 310, which completes an initial segmentation, as similarly described instep 210 of method 200. This initial segmentation produces a surface mesh comprised of vertices and edges. In the step 320, a volumetric mesh is formed, within the surface mesh of the initial segmentation. In the step 330, the processor 102 assigns each of the vertices of the surface mesh a mass point and each of the edges a spring. In the step 340, the display 106 displays a 2D reformatted view of a 2D view of the surface mesh along with the 2D view of the imaged organ such that the user may determine modifications to be made on the surface mesh.

In a step 350, the user draws a 2D contour of the imaged organ. The 2D contour may be drawn using a drawing tool such as, for example, Livewire, which allows the user to draw a contour based upon points selected on a surface of the imaged organ. Livewire is used by the user to draw connecting lines between each of the points to draw in the surface of the imaged organ. It will be understood by those of skill in the art that the greater a number of points on the surface of the imaged organ that are selected, the more accurate the 2D contour of the imaged organ will be. Thus, it will be understood by those of skill in the art that the user may select any number of points on the surface of the imaged organ, as desired.

The points of the 2D contour are then connected to points on a surface of the surface mesh, in a step 355. For each of the points of the 2D contour, the user selects a point on the surface of the surface mesh to which the 2D contour should be connected. In a step 360, for each of the selected points on the surface of the surface mesh, the processor 102 performs a fast-marching method, similar to the step 260, assigning timestamps to each of the vertices of the surface mesh. Steps 360-390 are substantially similar to steps 260-290, as described above in regard to method 200. Thus, in the step 370, a patch is selected based upon a time threshold and in the step 380, pull springs are attached to each of the vertices in the selected patch. It will be understood by those of skill in the art that the step 370 is not required. Where a patch is not selected, a pull spring may be added from a point of the 2D contour to a vertex of the surface mesh closest to the point of the 2D contour, in the step 380. In the step 390, the processor 102 calculates the Newtonian equation for each of the vertices with the pull spring attached thereto, to determine a distance by which the vertex will move when the selected point on the surface of the surface mesh is connected to the points on the 2D contour. It will be understood by those of skill in the art that the steps 360-390 may be repeated for each of the points on the surface of the surface mesh that are selected by the user to be connected to points on the 2D contour.

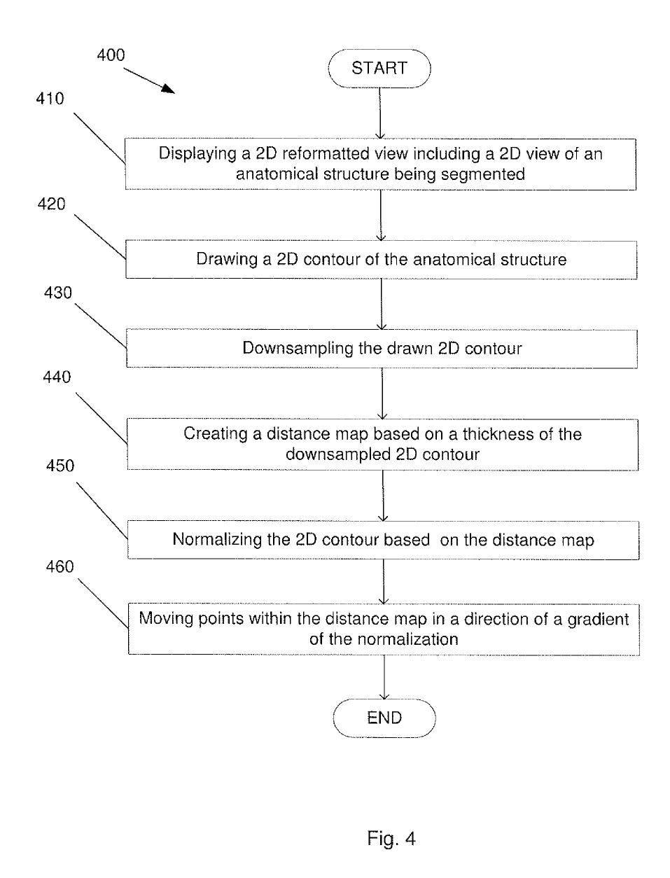

In another embodiment, as shown in FIG. 4, a method 400 comprises displaying a 2D reformatted view of an imaged organ or other anatomic structure on the display 106, in a step 410. In a step 420,the user draws a 2D contour of the imaged organ. The 2D contour is for example drawn using a drawing tool such as, for example, Livewire, which allows the user to draw a contour based upon points selected on a surface of the imaged organ. Livewire is used by the user to draw connecting lines between each of the points to draw in the surface of the imaged organ. It will be understood by those of skill in the art that the greater a number of points on the surface of the imaged organ that are selected, the more accurate the 2D contour of the imaged organ will be. Thus, it will be understood by those of skill in the art that the user may select any number of points on the surface of the imaged organ, as desired.

Alternatively, a Deriche filter is used for 3D edge and feature detection such that structures in the image are delineated and a 2D contour is determined by the processor 102. The Deriche filter recognizes feature values, which are then interpolated during a feature search such that outlines of structures are made clearly visible.

In a step 430, the processor 102 downsamples the drawn 2D contour by, for example, reducing a resolution of the 2D contour such that edges are blurred. It will be understood by those of skill in the art that downsampling of the 2D contour reduces any sharp edges of the 2D contour while increasing a thickness of the drawn 2D contour. The processor 102 then creates a distance map of the thickness of the downsampled 2D contour, in a step 440, measuring a distance between outer and inner edges of the downsampled 2D contour. In a step 450, the distance map is used to normalize the downsampled 2D contour using, for example, a Gaussian distribution, such that points of the 2D contour within the distance map are pulled in the direction of a gradient of normalization in a step 460. Moving the points within the distance map creates a smooth surface of the 2D contour, closer to a surface of the imaged structure. It will be understood by those of skill in the art that the steps 420-460 may be repeated as necessary, until the 2D contour, is sufficiently close to the surface of the imaged organ.

It is noted that the exemplary embodiments or portions of the exemplary embodiments may be implemented as a set of instructions stored on a computer readable storage medium, the set of instructions being executable by a processor.

It will be apparent to those skilled in the art that various modifications and variations can be made in the structure and methodology described herein. Thus, it is intended that the present disclosure cover any modifications and variations provided that they come within the scope of the appended claims and their equivalents.

It is also noted that the claims may include reference signs/numerals in accordance with PCT Rule 6.2(b). However, the present claims should not be considered to be limited to the exemplary embodiments corresponding to the reference signs/numerals.

What is claimed is:

1. A method for segmenting an anatomical structure, comprising:
initiating (210, 310) a segmentation algorithm, which produces a surface mesh of the anatomical structure from a series of volumetric images, the surface mesh formed of a plurality of polygons including vertices and edges;
assigning (230, 330) a spring to each of the edges and a mass point to each of the vertices of the surface mesh;
displaying (240, 340) a 2D reformatted view including a 2D view of the surface mesh and the anatomical structure;
adding (280, 380) pull springs to the surface mesh, the pull springs added based upon a selected point on a surface of the surface mesh; and
moving (290, 390) a portion of the surface mesh via an interactive point.

2. The method of claim 1, further comprising:
forming (220, 320) a volumetric mesh directly within the surface mesh, the volumetric mesh including vertices and edges corresponding to the vertices and edges of the surface mesh.

3. The method of claim 2, further comprising:
performing (260, 360) a fast marching method from the selected point, the fast marching assigning a timestamp to each of the vertices of the surface mesh, the timestamp based upon a distance from the selected point.

4. The method of claim 3, further comprising:
selecting (270, 370) a patch of polygons based upon a threshold of timestamp values.

5. The method of claim 3, wherein the interactive point is the selected point (250, 355) on the surface of the surface mesh.

6. The method of claim 5, wherein a pull spring is added to each of the vertices of the patch.

7. The method of claim 6, wherein a first end of the pull spring is attached to the vertex of the surface mesh and a second end is attached to a corresponding vertex of the volumetric mesh.

8. The method of claim 1, wherein each of the pull springs has a zero rest length.

9. The method of claim 6, wherein a spring constant of the pull spring is weighted based upon the corresponding timestamp value.

10. The method of claim 3, wherein the mass point of each of the vertices is weighted based upon the corresponding timestamp value.

11. The method of claim 1, wherein a mass point of each of the vertices is weighted based upon an image gradient.

12. The method of claim 1, further comprising:
drawing (350) a 2D contour of the anatomical structure, the 2D contour including a plurality of points connected to one another.

13. The method of claim 12, further comprising:
connecting one of the plurality of points of the 2D contour to the selected point on the surface of the surface mesh.

14. A system for segmenting an anatomical structure, comprising:
a processor (102) initiating a segmentation algorithm, which produces a surface mesh of the anatomical structure from a series of volumetric images, the surface mesh formed of a plurality of polygons including vertices and edges, and assigning a spring to each of the edges and a mass point to each of the vertices of the surface mesh;
a display (106) displaying a 2D reformatted view including a 2D view of the surface mesh and the anatomical structure; and
a user interface (104) adapted to allow a user to add pull springs to the surface mesh, the pull springs added based upon a selected point on a surface of the surface mesh and moving a portion of the surface mesh via an interactive point.

15. The system of claim 14, wherein the processor (102) forms a volumetric mesh directly within the surface mesh, the volumetric mesh including vertices and edges corresponding to the vertices and edges of the surface mesh.

16. The system of claim 15, wherein the processor (102) performs a fast marching from the selected point, the fast marching assigning a timestamp to each of the vertices of the surface mesh, the timestamp based upon a distance from the selected point.

17. The system of claim 16, wherein the user interface (104) is adapted to allow a user to select a patch of polygons based upon a threshold of timestamp values and the processor (102) adds a pull spring to each of the vertices within the patch.

18. The system of claim 14, wherein the user interface (104) is adapted to allow the user to draw a 2D contour of the anatomical structure, the 2D contour including a plurality of points connected to one another.

19. The system of claim 14, wherein the user interface (104) is adapted to allow the user to connect one of the plurality of points of the 2D contour to the selected point on the surface of the surface mesh.

20. A computer readable storage medium (108) including a set of instructions executable by a processor (102), the set of instructions operable to:
initiate (210, 310) a segmentation algorithm, which produces a surface mesh of an anatomical structure from a series of volumetric images, the surface mesh formed of a plurality of polygons including vertices and edges;
assign (230, 330) a spring to each of the edges and a mass point to each of the vertices of the surface mesh;
display (240, 340) a 2D reformatted view including a 2D view of the surface mesh and the anatomical structure;
add (280, 380) pull springs to the surface mesh, the pull springs added based upon a selected point on a surface of the surface mesh; and
move (290, 390) a portion of the surface mesh via an interactive point.
